(19) United States
(12) Patent Application Publication
(10) Pub. No.: US 2026/0309987 A1
(43) Pub. Date: Oct. 8, 2026

(54) VIRTUAL IMAGE DISPLAY APPARATUS AND OPTICAL UNIT

(71) Applicant: SEIKO EPSON CORPORATION, Tokyo (JP)

(72) Inventors: Yuiga HAMADE, MATSUMOTO-SHI (JP); Takashi TAKEDA, SUWA-SHI (JP)

(73) Assignee: SEIKO EPSON CORPORATION, Tokyo (JP)

(21) Appl. No.: 19/460,342

(22) Filed: Jan. 27, 2026

(30) Foreign Application Priority Data
Jan. 29, 2025 (JP) 2025-012801

(51) Int. Cl. G02B 27/01; G02F 1/13357

(52) U.S. Cl. CPC G02B 27/0172; G02F 1/133603; G02F 1/133605; G02B 2027/0178; G02B 2027/0196

(57) ABSTRACT

A virtual image display apparatus includes: a light source member configured to transmit external light in a first state and output illumination light containing first light in a first wavelength band in a second state; a display element facing the light source member and configured to further transmit the external light passing through the light source member in the first state, and transmit the illumination light output by the light source member to output video light in the second state; and an imaging optical system facing the light source member with the display element interposed therebetween and configured to transmit part of the external light in the first state, and bring the video light into focus in the second state. The light source member includes a first light emitter emitting the first light, and a first transmissive/reflective film reflecting the first light and transmitting the external light.

The present application is based on, and claims priority from JP Application Serial Number 2025-012801, filed Jan. 29, 2025, the disclosure of which is hereby incorporated by reference herein in its entirety.

### BACKGROUND

### 1. Technical Field

The present disclosure relates to a virtual image display apparatus and an optical unit that allow observation of a virtual image, and particularly to a virtual image display apparatus and an optical unit using a transmissive OLED panel and a transmissive liquid crystal panel.

### 2. Related Art

As a see-through-type virtual image display apparatus that allows visual recognition of the external space, there is a known apparatus including a liquid crystal panel having an image display region and a transparent display region formed to surround the image display region, and a light guide plate that guides backlight incident on an end portion thereof from a light source, the light guide plate including a light emitting region that irradiates the image display region of the liquid crystal panel with the backlight and a light transmitting region that transmits ambient light (WO 2016/056298). The virtual image display apparatus is so configured that ambient light reaches an observer from the light transmitting region of the light guide plate and the transparent display region of the liquid crystal panel, and the ambient light passes through the light emitting region of the light guide plate and the image display region of the liquid crystal panel and reaches the observer during a period in which the image display region is not irradiated with the backlight. The configuration described above achieves see-through display in which video light and ambient light are superimposed on each other.

WO 2016/056298 is an example of the related art.

In the virtual image display apparatus described above, there is a concern that the light output from the light guide plate leaks not only toward the liquid crystal panel but also toward the external space.

### SUMMARY

According to an aspect of the present disclosure, there is provided a virtual image display apparatus including: a light source member configured to transmit an external light in a first state and output an illumination light containing a first light in a first wavelength band in a second state; a display element provided to face the light source member and configured to further transmit the external light passing through the light source member in the first state, and transmit the illumination light output by the light source member to output a video light in the second state; and an imaging optical system provided to face the light source member with the display element interposed therebetween and configured to transmit at least part of the external light in the first state, and bring the video light into focus in the second state, the light source member including a first light emitter configured to emit the first light, and a first transmissive/reflective film provided on a side of the first light emitter that is a side opposite the display element and configured to reflect the first light and transmit the external light.

According to another aspect of the present disclosure, there is provided an optical unit comprising: a light source member configured to transmit an external light in a first state and output an illumination light containing a first light in a first wavelength band in a second state; a display element provided to face the light source member and configured to further transmit the external light passing through the light source member in the first state, and transmit the illumination light output by the light source member to output a video light in the second state; and an imaging optical system provided to face the light source member with the display element interposed therebetween and configured to transmit at least part of the external light in the first state, and bring the video light into focus in the second state, the light source member including a first light emitter configured to emit the first light, and a first transmissive/reflective film provided on a side of the first light emitter that is a side opposite the display element and configured to reflect the first light and transmit the external light.

### BRIEF DESCRIPTION OF THE DRAWINGS

FIG. 1 is a front view illustrating a state in which a display apparatus according to an embodiment is worn.

FIG. 2 is a conceptual perspective view illustrating the structure of a first display optical system.

FIG. 3 is a side cross-sectional view illustrating a light source member.

FIG. 4 is a graph showing the optical characteristic of a second transmissive/reflective film.

FIG. 5 is a conceptual enlarged cross-sectional view illustrating the structure of a display unit.

FIG. 6 illustrates the state of light passing through the display unit.

FIG. 7 is a side cross-sectional view showing an optical unit of a display optical system.

FIG. 8 shows the optical unit viewed from other directions.

FIG. 9 is a conceptual perspective view illustrating functions of first and second polarizing diffractive lenses.

FIG. 10 is a timing chart for illustrating a display operation performed by the display optical system.

### DESCRIPTION OF EMBODIMENTS

### First embodiment

A virtual image display apparatus according to a first embodiment of the present disclosure will be described below. The virtual image display apparatus according to the present embodiment is a display apparatus worn around the head, and is what is called a head mounted display.

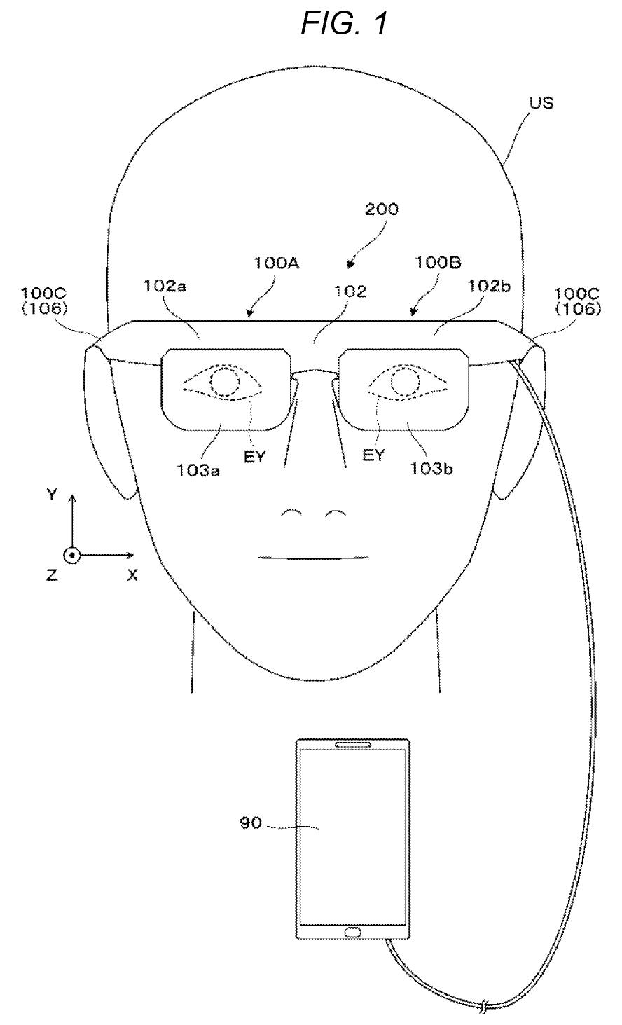

FIG. 1 is a front view illustrating a state in which the display apparatus according to the present embodiment is worn. A display apparatus (hereinafter also referred to as HMD) 200 causes an observer or wearer US, who wears the HMD 200, to recognize a video in the form of virtual images. In FIG. 1 and other figures, X, Y, and Z form an orthogonal coordinate system, an X-axis being an axis along a lateral direction in which both eyes EY of the observer or wearer US wearing the HMD 200 are arranged, a +X side corresponding to a left direction viewed from the wearer US, and a −X side corresponding to a right direction viewed from the wearer US. A Y-axis is an axis along the upward-downward direction perpendicular to the lateral direction, in which the eyes EY of the wearer US are arranged, a +Y side corresponding to the upward direction, and a −Y side corresponding to the downward direction. A Z-axis is an axis along the frontward-rearward direction for the wearer US, a +Z side corresponding to the front side with respect to the wearer US, and a −Z side corresponding to the rear side with respect to the wearer US.

The HMD 200 includes a first virtual image display apparatus 100A for the right eye, a second virtual image display apparatus 100B for the left eye, a pair of temples 100C, which support the virtual image display apparatuses 100A and 100B, and a user terminal 90, which is an information terminal. The first virtual image display apparatus 100A includes a first display driver 102a disposed in an upper portion of the display apparatus, and a first display optical system 103a, which covers the front of the right eye. The second virtual image display apparatus 100B includes a second display driver 102b disposed in an upper portion of the display apparatus, and a second display optical system 103b, which covers the front of the left eye. The HMD 200, which is the combination of the first virtual image display apparatus 100A and the second virtual image display apparatus 100B, is also a virtual image display apparatus in a broad sense. The pair of temples 100C are mounting members mounted or supports 106 worn at the head of the wearer US, and support the upper ends of the pair of display optical systems 103a and 103b via the display drivers 102a and 102b integrated with each other in appearance. The combination of the pair of display drivers 102a and 102b is referred to as a drive apparatus 102.

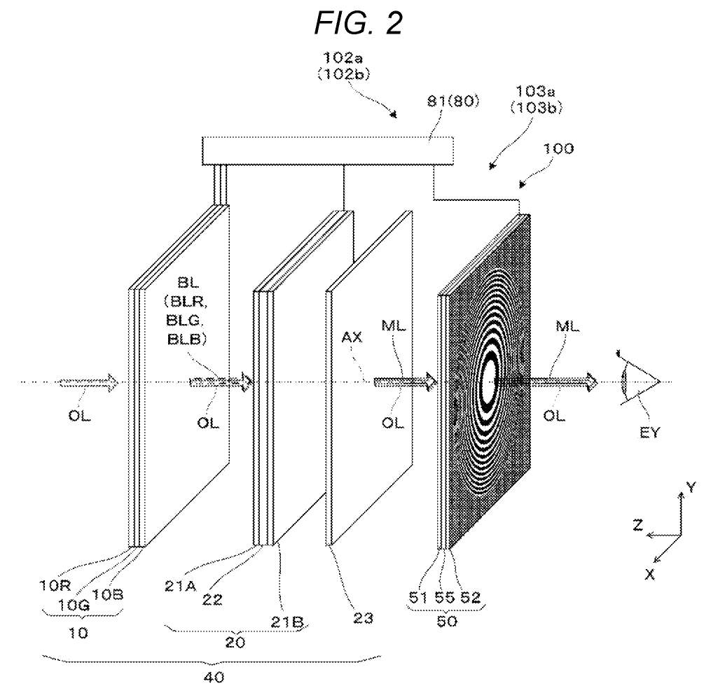

FIG. 2 is a conceptual perspective view illustrating the structure of the first display optical system 103a. The first display optical system 103aincludes a plate-shaped display unit 40, which forms a two-dimensional image and outputs video light ML corresponding to the two-dimensional image, and a plate-shaped imaging optical system 50, which functions as a lens affecting the video light ML output from the display unit 40 and forms a virtual image. In FIG. 2, some distances between the elements are enlarged for easier understanding of the configuration of the first display optical system 103a.

The display unit 40 includes a light source member 10 including a first light source 10R, which generates first light, a second light source 10G, which generates second light, and a third light source 10B, which generates third light, a display element 20, which forms and outputs the video light ML, and a quarter-wave plate 23.

The light source member 10 outputs backlight (illumination light) BL containing first backlight (first light) BLR, second backlight (second light) BLG, and third backlight (third light) BLB. The colors of the multiple types of backlight BLR, BLG, and BLB are so selected that the backlight BL, into which the multiple types of backlight BLR, BLG, and BLB are superimposed on one another, is white light.

The display unit 40 is driven by a drive circuit 81 of a controller 80 incorporated in the first display driver 102a or the drive apparatus 102 to operate. The display element 20 of the display unit 40 is disposed close to the eye EY with the imaging optical system 50 interposed therebetween, and enables observation of a virtual image formed by the video light ML and see-through viewing of the outside space. In the first display optical system 103a, the distance between the eye EY and the imaging optical system 50 in the direction of an optical axis AX ranges, for example, from about 10 mm to 20 mm. The distance between a transmissive liquid crystal panel 22 of the display unit 40 and the imaging optical system 50 in the direction of the optical axis AX ranges, for example, from about 5 mm to 25 mm.

The display element 20 is a plate-shaped member extending along an XY plane perpendicular to the optical axis AX, and includes a first polarizer 21A, the transmissive liquid crystal panel 22, and a second polarizer 21B sequentially arranged from the side facing the outside space. The display element 20 has a structure in which the polarizers 21A and 21B and the transmissive liquid crystal panel 22 are stacked on each other into a single unit surrounded by a frame that is not shown. The first polarizer 21A and the transmissive liquid crystal panel 22 are disposed close to each other at a distance smaller than or equal to a predetermined value. The transmissive liquid crystal panel 22 and the second polarizer 21B are disposed close to each other at a distance smaller than or equal to a predetermined value. The transmissive liquid crystal panel 22 is an imager that forms first video light made of a first color component, second video light made of a second color component, and third video light made of a third color component, the first video light, the second video light, and the third video light constituting the video light ML. Note that the transmissive liquid crystal panel 22 includes multiple pixels arranged in a matrix along an XY plane.

The imaging optical system 50 is disposed at a side of the display unit 40 or the display element 20 that is the side facing the face of the observer, that is, on the −Z side of the display unit 40 or the display element 20, and covers the front of the eye. The imaging optical system 50 is a plate-shaped member extending along an XY plane, and includes a first polarizing diffractive lens 51, a switching half-wave plate 55, and a second polarizing diffractive lens 52 sequentially arranged from the side facing the outside space. The imaging optical system 50 has a structure in which optical elements that constitute the imaging optical system 50, that is, the first polarizing diffractive lens 51, the switching half-wave plate 55, and the second polarizing diffractive lens 52 are disposed so as to be close to each other and parallel to each other, and the optical elements are integrated into a single unit surrounded by a frame that is not shown. The integration makes the optical performance of the imaging optical system 50 stable and the thickness of the imaging optical system 50 small. Note that, including a case where another optical element is disposed between the first polarizing diffractive lens 51 and the second polarizing diffractive lens 52 in addition to the switching half-wave plate 55, the elements described above can be directly fixed to each other via an adhesive into a single integrated unit, or can be in close contact with and fixed to each other at the outer circumference into a single integrated unit. The distance between the first polarizing diffractive lens 51 and the second polarizing diffractive lens 52 can be adjusted before the integration operation. The imaging optical system 50 is a dynamic optical element that acts differently in accordance with the state of the switching half-wave plate 55. The imaging optical system 50 functions as a lens affecting the video light ML output from the display element 20. That is, the imaging optical system 50 forms images of the multiple pixels as a whole, which are contained in the transmissive liquid crystal panel 22, and enables the observer to observe a video formed on the transmissive liquid crystal panel 22 as virtual images. The imaging optical system 50 further functions as a plane-parallel plate affecting external light OL passing through the display element 20. That is, the external light OL passes straight through the display element 20 to be observed as a direct-view image.

The second display optical system 103b is optically the same as the first display optical system 103a or is a horizontally flipped version of the first display optical system 103a, and will therefore not be described in detail.

Note that an optical apparatus that is the first virtual image display apparatus 100A from which the controller 80 is excluded is called an optical unit 100. Similarly, an optical apparatus that is the second virtual image display apparatus 100B from which the controller 80 is excluded is called the optical unit 100.

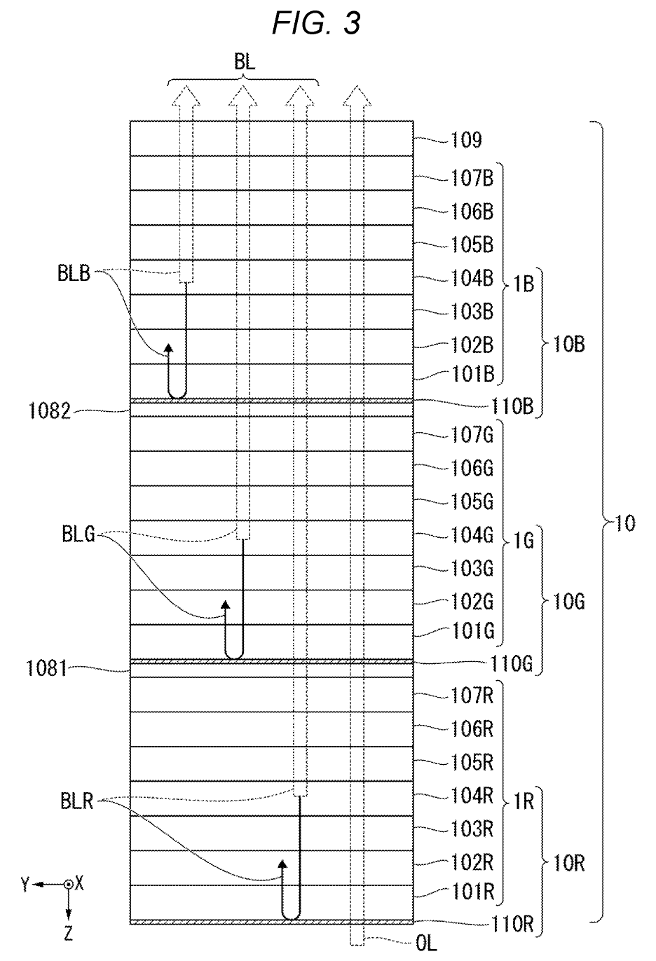

FIG. 3 is a side cross-sectional view illustrating the light source member 10. The light source member 10 includes the first light source 10R, a first adhesive layer 1081, the second light source 10G, a second adhesive layer 1082, the third light source 10B, and a cover member 109, as shown in FIG. 3. The first light source 10R, the first adhesive layer 1081, the second light source 10G, the second adhesive layer 1082, the third light source 10B, and the cover member 109 are stacked in this order in a −Z direction in the orthogonal coordinate system. The −Z direction is a direction in which the external light OL externally enters the light source member 10, passes through the light source member 10, and then travels toward the display element 20, the imaging optical system 50, and the eye EY of the wearer US, as shown in FIG. 2.

In the example shown in FIG. 3, the first light source 10R includes a first transmissive OLED element (first light emitter) 1R, which emits the first backlight BLR, and a first transmissive/reflective film 110R. The first transmissive OLED element 1R is provided on the +Z side of the second transmissive OLED element 1G, which will be described later, the +Z side being the side opposite the display element 20. The first transmissive OLED element 1R includes a first transparent substrate 101R, a first transparent anode 102R, a first hole transport layer 103R, a first light emitting layer 104R, a first electron transport layer 105R, a first transparent cathode 106R, and a first sealing layer 107R. The first transparent substrate 101R, the first transparent anode 102R, the first hole transport layer 103R, the first light emitting layer 104R, the first electron transport layer 105R, the first transparent cathode 106R, and the first sealing layer 107R are stacked in this order in the −Z direction in the orthogonal coordinate system. The first transmissive/reflective film 110R is provided on a side of the first transparent substrate 101R of the first transmissive OLED element 1R that is the side opposite the display element 20.

Note that it is desirable to form the first transmissive/reflective film 110R at the first transparent substrate 101R before forming the OLED element on the first transparent substrate 101R. The reason for this is to prevent heat generated when the first transmissive/reflective film 110R is formed from being transferred, for example, to the first light emitting layer 104R, which is vulnerable to heat.

When an appropriate voltage is applied to the space between the first transparent anode 102R and the first transparent cathode 106R, the first transmissive OLED element 1R outputs the first light from the first light emitting layer 104R as the first backlight BLR. A first wavelength to which the first backlight BLR belongs corresponds, for example, to red, and may fall within a range from 600 nm to 640 nm, more preferably within a range from 610 nm to 630 nm.

The second light source 10G includes the second transmissive OLED element (second light emitter) 1G, which emits the second backlight BLG, and a second transmissive/reflective film 110G. The second transmissive OLED element 1G includes a second transparent substrate 101G, a second transparent anode 102G, a second hole transport layer 103G, a second light emitting layer 104G, a second electron transport layer 105G, a second transparent cathode 106G, and a second sealing layer 107G. The second transparent substrate 101G, the second transparent anode 102G, the second hole transport layer 103G, the second light emitting layer 104G, the second electron transport layer 105G, the second transparent cathode 106G, and the second sealing layer 107G are stacked in this order in the −Z direction in the orthogonal coordinate system. The second transmissive/reflective film 110G is provided on a side of the second transparent substrate 101G of the second transmissive OLED element 1G that is the side opposite the display element 20.

Note that it is desirable to form the second transmissive/reflective film 110G at the second transparent substrate 101G before forming the OLED element on the second transparent substrate 101G. The reason for this is to prevent heat generated when the second transmissive/reflective film 110G is formed from being transferred to the second light emitting layer 104G, which is vulnerable to heat, via the second transparent substrate 101G.

When an appropriate voltage is applied to the space between the second transparent anode 102G and the second transparent cathode 106G, the second transmissive OLED element 1G outputs the second light from the second light emitting layer 104G as the second backlight BLG. A second wavelength to which the second backlight BLG belongs corresponds, for example, to green, and may fall within a range from 500 nm to 550 nm, more preferably within a range from 520 nm to 540 nm.

Furthermore, the third light source 10B includes a third transmissive OLED element 1B, which outputs the third backlight BLB as the third light, and a third transmissive/reflective film 110B. The third transmissive OLED element 1B is provided on the −Z side of the second transmissive OLED element 1G, which is the side facing the display element 20. The third transmissive OLED element 1B includes a third transparent substrate 101B, a third transparent anode 102B, a third hole transport layer 103B, a third light emitting layer 104B, a third electron transport layer 105B, a third transparent cathode 106B, and a third sealing layer 107B. The third transparent substrate 101B, the third transparent anode 102B, the third hole transport layer 103B, the third light emitting layer 104B, the third electron transport layer 105B, the third transparent cathode 106B, and the third sealing layer 107B are stacked in this order in the −Z direction in the orthogonal coordinate system. The third transmissive/reflective film 110B is provided on a side of the third transparent substrate 101B of the third transmissive OLED element 1B that is the side opposite the display element 20.

Note that it is desirable to form the third transmissive/reflective film 110B at the third transparent substrate 101B before forming the OLED element on the third transparent substrate 101B. The reason for this is to prevent heat generated when the third transmissive/reflective film 110B is formed from being transferred, for example, to the third light emitting layer 104B, which is vulnerable to heat.

When an appropriate voltage is applied to the space between the third transparent anode 102B and the third transparent cathode 106B, the third transmissive OLED element 1B outputs the third light from the third light emitting layer 104B as the third backlight BLB. A third wavelength band to which the third backlight BLB belongs corresponds, for example, to blue, and may fall within a range from 450 nm to 480 nm, more preferably within a range from 450 nm to 460 nm.

The first light emitting layer 104R, the second light emitting layer 104G, and the third light emitting layer 104B may each include a single light emitter, or may include multiple light emitters arranged in a mesh in an XY plane. In the present embodiment, a configuration in which the light emitting layers 104R, 104G, and 104B each include a single light emitter will be described.

The first light source 10R, the second light source 10G, and the third light source 10B are each an integrated single unit with elements thereof bonded to each other with an adhesive such as resin. In more detail, the first adhesive layer 1081 is provided between the first sealing layer 107R of the first transmissive OLED element 1R and the second transmissive/reflective film 110G provided at the second transmissive OLED element 1G, and the space between the +Z-side surface of the first sealing layer 107R and the −Z-side surface of the second transmissive/reflective film 110G is filled with the first adhesive layer 1081, which is an adhesive.

Similarly, the second adhesive layer 1082 is provided between the second sealing layer 107G of the second transmissive OLED element 1G and the third transmissive/reflective film 110B provided at the third transmissive OLED element 1B, and the space between the −Z-side surface of the second sealing layer 107G and the +Z-side surface of the third transmissive/reflective film 110B is filled with the second adhesive layer 1082, which is an adhesive.

Filling the spaces between the three transmissive OLED elements with the adhesives as described above allows the entire light source member 10 to have higher transmittance at least in the visible light wavelength band than in a case where air layers are provided between the three transmissive OLED elements.

The cover member 109, which protects the third transmissive OLED element 1B, is provided at the −Z-side surface of the third sealing layer 107B of the third transmissive OLED element 1B. Since the second transmissive OLED element 1G is bonded to the −Z-side surface of the first sealing layer 107R of the first transmissive OLED element 1R, a cover member that protects the first transmissive OLED element 1R is omitted. Similarly, since the third transmissive OLED element 1B is bonded to the −Z-side surface of the second sealing layer 107G of the second transmissive OLED element 1G, a cover member that protect the second transmissive OLED element 1G is omitted. Integrating the three transmissive OLED elements with each other as described above allows two cover members to be omitted. As a result, the light source member 10 can be made thinner than in a case where the cover members are not omitted.

The first backlight BLR emitted by the first light emitting layer 104R of the first light source 10R travels in the −Z direction, passes through the second light source 10G, the third light source 10B, and the cover member 109, and travels toward the display element 20, the imaging optical system 50, and the eye EY of the wearer US. The second backlight BLG emitted by the second light emitting layer 104G of the second light source 10G travels in the −Z direction, passes through the third light source 10B and the cover member 109, and travels toward the display element 20, the imaging optical system 50, and the eye EY of the wearer US. The third backlight BLB emitted by the third light emitting layer 104B of the third light source 10B travels in the −Z direction, passes through the cover member 109, and travels toward the display element 20, the imaging optical system 50, and the eye EY of the wearer US.

In the light source member 10 in the present embodiment, part of the first backlight BLR travels in the +Z direction, reaches the first transparent substrate 101R, and is incident on the first transmissive/reflective film 110R provided on the +Z side of the first transparent substrate 101R, which is the side opposite the display element 20.

The first transmissive/reflective film 110R has an optical characteristic of reflecting light in a red wavelength band corresponding to the first backlight BLR and transmitting the external light OL. The first transmissive/reflective film 110R is configured with a dielectric multilayer film.

Note that the first transmissive/reflective film 110R also reflects components of the external light OL that belong to the same wavelength to which the first backlight BLR belongs, but the amount of the components contained in the external light OL is small, so that the reflection does not greatly affect the external light OL.

Part of the second backlight BLG travels in the +Z direction, reaches the second transparent substrate 101G, and is incident on the second transmissive/reflective film 110G provided on the +Z side of the second transparent substrate 101G, which is the side opposite the display element 20.

The second transmissive/reflective film 110G has an optical characteristic of reflecting light in a green wavelength band corresponding to the second backlight BLG and transmitting the external light OL. The second transmissive/reflective film 110G is configured with a dielectric multilayer film. The second transmissive/reflective film 110G transmits the first backlight BLR reflected off the first transmissive/reflective film 110R, which will be described later.

Note that the second transmissive/reflective film 110G also reflects components of the external light OL that belong to the same wavelength to which the second backlight BLG belongs, but the amount of the components contained in the external light OL is small, so that the reflection does not greatly affect the external light OL.

Part of the third backlight BLB travels in the +Z direction, reaches the third transparent substrate 101B, and is incident on the third transmissive/reflective film 110B provided on the +Z side of the third transparent substrate 101B, which is the side opposite the display element 20.

The third transmissive/reflective film 110B has an optical characteristic of reflecting light in a blue wavelength band corresponding to the third backlight BLB and transmitting the external light OL. The third transmissive/reflective film 110Bis configured with a dielectric multilayer film. The third transmissive/reflective film 110Btransmits the second backlight BLG reflected off the second transmissive/reflective film 110G and the first backlight BLR reflected off the first transmissive/reflective film 110R as described above.

Note that the third transmissive/reflective film 110B also reflects components of the external light OL that belong to the same wavelength to which the third backlight BLB belongs, but the amount of the components contained in the external light OL is small, so that the reflection does not greatly affect the external light OL.

The first transmissive/reflective film 110R, the second transmissive/reflective film 110G, and the third transmissive/reflective film 110B have the same configuration except that the three types of light reflected off the three transmissive/reflective films have different wavelength band. The optical characteristics of the transmissive/reflective films will be described with reference to that of the second transmissive/reflective film 110G, which reflects the second backlight BLG from the second light source 10G located at the center of the light source member 10 out of the three light sources.

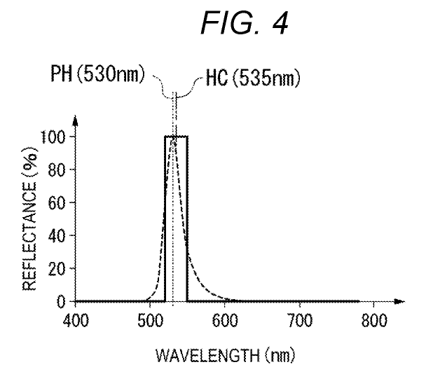

FIG. 4 is a graph showing the optical characteristic of the second transmissive/reflective film 110G. The horizontal axis of FIG. 4 corresponds to the wavelength of the light incident on the second transmissive/reflective film 110G, and the wavelength is expressed in nanometers. The vertical axis of FIG. 4 corresponds to the reflectance of the second transmissive/reflective film 110G, which is expressed in %. Note that FIG. 4 also shows the spectrum of the emitted second backlight BLG incident on the second transmissive/reflective film 110G for the sake of understanding of the description.

In the present embodiment, a reflection center wavelength of the light reflected off the second transmissive/reflective film 110G is set so as to fall within the second wavelength band of the second backlight BLG. The second transmissive/reflective film 110G has an optical characteristic corresponding to a wavelength band at least wider than the full width at half maximum of the wavelength band of the second backlight BLG.

Specifically, when a peak wavelength PH of the second backlight BLG is 530 nm, and the full width at half maximum is 25 nm, the second transmissive/reflective film 110G is configured with a dielectric multilayer film having an optical characteristic of having a reflection center wavelength HC of 535 nm and a wavelength width of 30 nm, that is, a characteristic of reflecting light in a wavelength band from 520 nm to 550 nm, as shown in FIG. 4.

It is difficult to design the second transmissive/reflective film 110G to reflect the entire second backlight BLG in terms of wavelength band. To address the difficulty, the second transmissive/reflective film 110G in the present embodiment has a reflection center wavelength HC shifted toward a wavelength longer than the peak wavelength PH of the second backlight BLG. There are two reasons for employing this configuration. The first reason is that an organic OLED element emits light having higher intensity at a longer wavelength than the peak wavelength PH than the intensity of light at a shorter wavelength than the peak wavelength PH. The second reason is that human visual sensitivity peaks at about 555 nm, so that it is preferable to reflect light having wavelengths close to 555 nm as much as possible to make the light readily visible.

The second transmissive/reflective film 110G in the present embodiment, which has a reflection center wavelength HC shifted toward 555 nm from the peak wavelength PH of the second backlight BLG, can therefore efficiently reflect highly visible components in the wavelength band to which the second backlight BLG belongs.

The present discloser conducted a simulation for a case where the second transmissive/reflective film 110G having the optical characteristic shown in FIG. 4 is provided and a case where the second transmissive/reflective film 110G is not provided. As a result, the present discloser ascertained that the amount of light leaking toward the external space was reduced by providing the second transmissive/reflective film 110G and the amount of light incident on the display element 20 was increased by a factor of 1.59 as compared with those in the case where the second transmissive/reflective film 110G was not provided.

Therefore, in the light source member 10 in the present embodiment, the second transmissive/reflective film 110G can reflect the second backlight BLG to cause it to enter the display element 20. The second backlight BLG reflected off the second transmissive/reflective film 110G passes through the third light source 10B and the cover member 109, and travels toward the display element 20, the imaging optical system 50, and the eye EY of the wearer US. According to the light source member 10 in the present embodiment, the efficiency at which the second backlight BLG emitted from the second light emitting layer 104G of the second light source 10G is used can be improved. In addition, since components in a highly visible wavelength band out of the components contained in the second backlight BLG are efficiently reflected, the wearer US can favorably visually recognize video light having the color corresponding to the second backlight BLG.

The first transmissive/reflective film 110R differs from the second transmissive/reflective film 110G in terms of the wavelength band of the incident light, but has a basic configuration that is the same as that of the second transmissive/reflective film 110G. The first transmissive/reflective film 110R is so set that the reflection center wavelength of the light reflected off the first transmissive/reflective film 110R falls within the first wavelength band of the first backlight BLR. The first transmissive/reflective film 110R has an optical characteristic corresponding to a wavelength band at least wider than the full width at half maximum of the wavelength band of the first backlight BLR.

For example, when the peak wavelength of the first backlight BLR is 625 nm, and the full width at half maximum is 25 nm, the first transmissive/reflective film 110R is configured with a dielectric multilayer film having an optical characteristic of having a reflection center wavelength of 615 nm and a wavelength width of 30 nm, that is, a characteristic of reflecting light in a wavelength band from 600 nm to 630 nm.

It is difficult to design the first transmissive/reflective film 110R to reflect the entire first backlight BLR in terms of wavelength band. Since the first backlight BLR in the red wavelength band has wavelengths longer than 555 nm described above, the visibility of the first backlight BLR rapidly decreases as the wavelength thereof increases. Therefore, unlike the second transmissive/reflective film 110G, the first transmissive/reflective film 110R has a reflection center wavelength shifted toward a wavelength shorter than the peak wavelength of the first backlight BLR to reflect light having wavelengths close to 555 nm as much as possible. The first transmissive/reflective film 110R can therefore efficiently reflect highly visible components in the wavelength band to which the first backlight BLR belongs.

As described above, the first backlight BLR reflected off the first transmissive/reflective film 110R passes through the second light source 10G, the third light source 10B, and the cover member 109, and travels toward the display element 20, the imaging optical system 50, and the eye EY of the wearer US. According to the light source member 10 in the present embodiment, the efficiency at which the first backlight BLR emitted from the first light emitting layer 104R of the first light source 10R is used can be improved. In addition, since components in a highly visible wavelength band out of the components contained in the first backlight BLR are efficiently reflected, the wearer US can favorably visually recognize video light having the color corresponding to the first backlight BLR.

The third transmissive/reflective film 110B differs from the second transmissive/reflective film 110G in terms of the wavelength band of the incident light, but has a basic configuration that is the same as that of the second transmissive/reflective film 110G. The third transmissive/reflective film 110Bis so set that the reflection center wavelength of the light reflected off the third transmissive/reflective film 110B falls within the third wavelength band of the third backlight BLB. The third transmissive/reflective film 110Bhas an optical characteristic corresponding to a wavelength band at least wider than the full width at half maximum of the wavelength band of the third backlight BLB.

For example, when the peak wavelength of the third backlight BLB is 455 nm, and the full width at half maximum is 25 nm, the third transmissive/reflective film 110B is configured with a dielectric multilayer film having an optical characteristic of having a reflection center wavelength of 465 nm and a wavelength width of 30 nm, that is, a characteristic of reflecting light in a wavelength band from 450 nm to 480 nm.

It is difficult to design the third transmissive/reflective film 110B to reflect the entire third backlight BLB in terms of wavelength band. The third backlight BLB having the blue wavelength band has wavelengths shorter than 555 nm, as the second backlight BLG. The third transmissive/reflective film 110Btherefore has a reflection center wavelength shifted toward a wavelength longer than the peak wavelength of the third backlight BLB to reflect light having wavelengths close to 555 nm as much as possible, as the second transmissive/reflective film 110G. The third transmissive/reflective film 110Bcan therefore efficiently reflect highly visible components in the wavelength band to which the third backlight BLB belongs.

The third backlight BLB reflected off the third transmissive/reflective film 110B passes through the cover member 109 and travels toward the display element 20, the imaging optical system 50, and the eye EY of the wearer US. According to the light source member 10 in the present embodiment, the efficiency at which the third backlight BLB emitted from the third light emitting layer 104B of the third light source 10B is used can be improved. In addition, since components in a highly visible wavelength band out of the components contained in the third backlight BLB are efficiently reflected, the wearer US can favorably visually recognize video light having the color corresponding to the third backlight BLB.

In the example shown in FIG. 3, out of the three transmissive OLED elements provided in the light source member 10, the third transmissive OLED element 1B, which emits the third backlight BLB corresponding to blue, is disposed at a position closest to the display element 20. Similarly, the first transmissive OLED element 1R, which emits the first backlight BLR corresponding to red, is disposed at a position farthest from the display element 20, and the second transmissive OLED element 1G, which emits the second backlight BLG corresponding to green, is disposed at an intermediate position. The arrangements described above are merely presented by way of example, and do not limit the present embodiment. Note, however, that the light emitting layers 104R, 104G, and 104B as organic layers provided in the OLED elements are relatively likely to absorb light having the wavelengths corresponding to blue. It is therefore preferable to arrange the transmissive OLED elements in a way that the light emitted from the third transmissive OLED element 1B passes through neither the second transmissive OLED element 1G nor the first transmissive OLED element 1R as possible as the design permits. As an example, the third transmissive OLED element 1B out of the three transmissive OLED elements provided in the light source member 10 may be disposed at a position closest to the display element 20.

Furthermore, to efficiently extract the first backlight BLR, the second backlight BLG, and the third backlight BLB emitted by the respective transmissive OLED elements out of the light source member 10, the film thicknesses of the hole transport layers 103R, 103G, and 103B and the electron transport layers 105R, 105G, and 105B provided in the light source member 10 may be set as follows: That is, the film thicknesses of the hole transport layers 103R, 103G, and 103B and the electron transport layers 105R, 105G, and 105B are made greater in the first transmissive OLED element 1R, smaller in the third transmissive OLED element 1B, and intermediate in the second transmissive OLED element 1G. As a more specific example, the thickness of the first hole transport layer 103R is set to 106 nm, the thickness of the second hole transport layer 103G is set to 75 nm, and the thickness of the third hole transport layer 103B is set to 50 nm. The thickness of the first electron transport layer 105R is set to 66 nm, the thickness of the second electron transport layer 105G is set to 48 nm, and the thickness of the third electron transport layer 105B is set to 33 nm. The thickness of each of the second light emitting layer 104G, the first light emitting layer 104R, and the third light emitting layer 104B is set to 30 nm. In this case, the total thickness of the first hole transport layer 103R, the first light emitting layer 104R, and the first electron transport layer 105R is 202 nm. The total thickness of the second hole transport layer 103G, the second light emitting layer 104G, and the second electron transport layer 105G is 153 nm. The total thickness of the third hole transport layer 103B, the third light emitting layer 104B, and the third electron transport layer 105B is 113 nm.

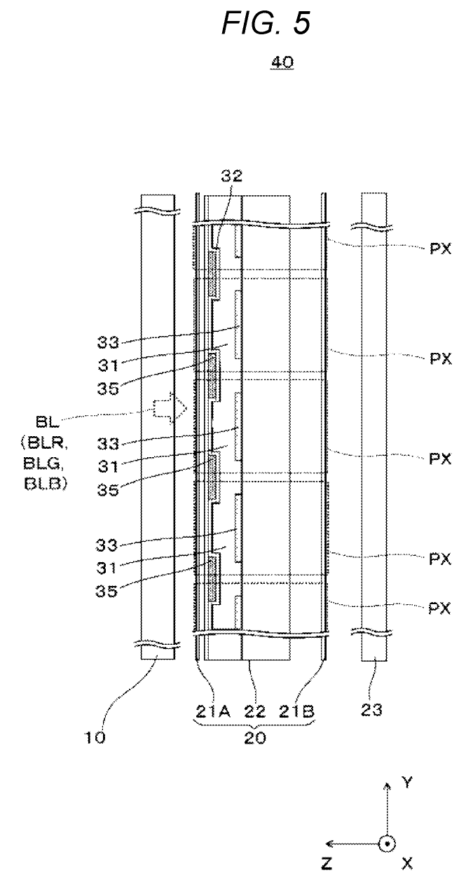

FIG. 5 is a conceptual enlarged cross-sectional view illustrating the structure of the display unit 40. Referring to FIG. 5, the light source member 10 generates the three types of color backlight BLR, BLG, and BLB in a time division manner as the backlight BL, and supplies one at a time out of the three types of color backlight BLR, BLG, and BLB to the transmissive liquid crystal panel 22 of the display element 20.

The display element 20 is disposed at a side of the light source member 10 or the first polarizer 21A that is the side facing the face of the observer, that is, on the −Z side of the light source member 10 or the first polarizer 21A. The display element 20 includes the transmissive liquid crystal panel 22 and the pair of polarizers 21A and 21B, which sandwich the transmissive liquid crystal panel 22. In this case, the display element 20 is, for example, a modulator made of IPS (in-plane switching) liquid crystal material and operates on a pixel basis throughout the pixels PX. Each of the pixels PX includes no filter and is colorless. The display element 20, when no electric field is applied thereto, does not rotate the polarization direction of the incident light, but when an electric field is applied thereto, rotates the polarization direction of the incident light. In this case, the pair of polarizers 21Aand 21B are absorptive polarization elements, and are so disposed that the polarization directions thereof intersect with each other, more specifically, the polarization directions thereof are perpendicular to each other. The display element 20 can switch the state thereof between ON and OFF on a pixel basis throughout the pixels PX in accordance with a drive signal from the drive circuit 81, and can transmit part of the incident light at any gray level between the levels corresponding to ON and OFF. To this end, the transmissive liquid crystal panel 22 includes not only a liquid crystal layer 31, a common electrode 32, pixel electrodes 33, and a black matrix 35 but also scan lines, signal lines, switch elements, and the like, none of which is shown. The transmissive liquid crystal panel 22 is preferably configured with a high-temperature polysilicon (HTPS) panel to achieve high-definition display.

Instead, the display element 20 or the transmissive liquid crystal panel 22, when no electric field is applied thereto, may rotate the polarization direction of the incident light, but when an electric field is applied thereto, may not rotate the polarization direction of the incident light. In this case, the pair of polarizers 21A and 21B are so disposed that the polarization directions thereof are parallel to each other.

The quarter-wave plate 23 has a principal axis, for example, between the X direction and the Y direction, and converts the video light ML and the external light OL (see FIG. 2) from linearly polarized light, into circularly polarized light. The video light ML being circularly polarized light means that in terms of the vibration of the electric field component or the magnetic field component of the video light ML, the direction of the vibration rotates at the frequency of the video light ML in a plane perpendicular to the traveling direction of the light, and that the amplitude of the vibration is fixed irrespective of the direction thereof. Right-handed circularly polarized light has an electric field component having a vibration direction that rotates clockwise when viewed from an observer facing the beam traveling toward the observer, and left-handed circularly polarized light has an electric field component having a vibration direction that rotates counterclockwise. Note, however, in the present specification that as long as the video light ML primarily contains right-handed circularly polarized light, the video light ML is assumed to be right-handed circularly polarized light RCP even when the video light ML contains, for example, linearly polarized light polarized in a specific direction. Similarly, as long as the video light ML primarily contains left-handed circularly polarized light, the video light ML is assumed to be left-handed circularly polarized light LCP. In the present specification, the right-handed circularly polarized light RCP is also called right circularly polarized light RCP, and the left-handed circularly polarized light LCP is also called left circularly polarized light LCP.

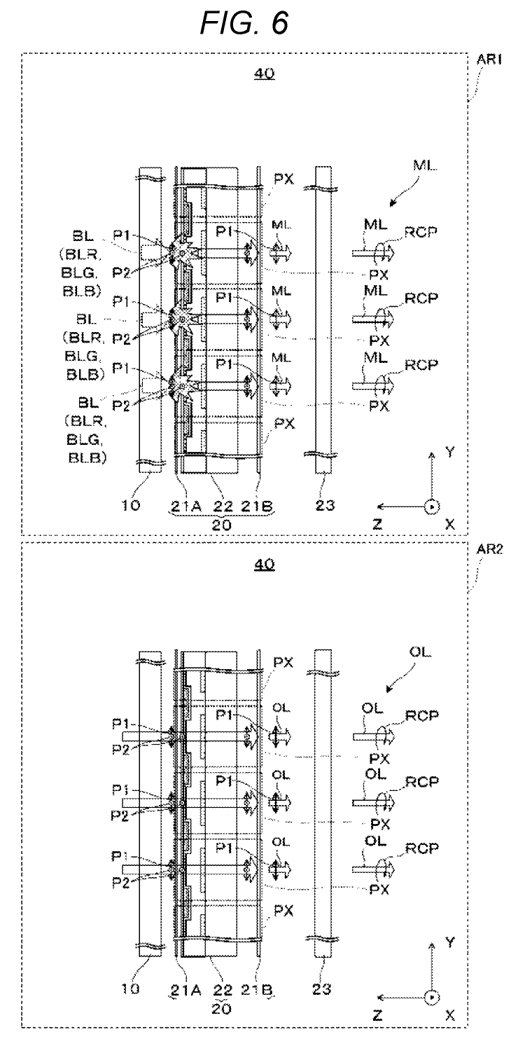

FIG. 6 illustrates the state of the light passing through the display unit 40. In FIG. 6, the upper part shows a state AR1, in which the first display optical system 103a operates in a video observation period and the display unit 40 operates in a video display state, and the lower part shows a state AR2, in which the first display optical system 103a operates in an external light observation period and the display unit 40 operates in a non-video display state. In the present specification, the state AR2, in which the display unit 40 operates in the non-video display state in the external light observation period shown in the lower part of FIG. 6, is called a first state, and the state AR1, in which the display unit 40 operates in the video display state in the video observation period shown in the upper part of FIG. 6, is called a second state.

Referring to FIG. 6, when the display unit 40 operates in the video display state in the video observation period, any one of the light emitting layers 104R, 104G, and 104B shown in FIG. 3 in the light source member 10 selectively emits light in accordance with a control signal from the controller 80 shown in FIG. 2, and at least part of any one of BLR, BLG, and BLB of the backlight BL is output toward the display element 20. The transmissive liquid crystal panel 22 is illuminated with the backlight BL (BLR, BLG, and BLB) as second polarized light P2, which is laterally or horizontally polarized light, via the first polarizer 21A of the display element 20. That is, the colorless pixels PX, which constitute the display element 20, are each illuminated. The video light ML having passed through the transmissive liquid crystal panel 22 is the backlight BL (BLR, BLG, and BLB) having a polarization plane rotated in accordance with the drive signal, and only first linearly polarized light P1, which is longitudinally or vertically polarized light, is output via the second polarizer 21B. The video light ML output from each of the pixels PX of the display element 20 passes through the quarter-wave plate 23, which converts the video light ML from the first polarized light P1 into the right circularly polarized light RCP.

When the display unit 40 operates in the non-video display state in the external light observation period, it is assumed that the light source member 10 operates in a non-light emission state, that is, a turn-off state. At this timing, the external light OL enters the display element 20. In this process, the pixels PX of the display element 20 operate, for example, in a normally-off mode and are caused to operate in a maximum transmission state by the drive signal, and the second polarized light P2 out of the external light OL incident on the pixels PX of the display element 20 travels straight through the display element 20, that is, the pixels PX and is converted into the first polarized light P1. The external light OL output from the pixels PX of the display element 20 passes through the quarter-wave plate 23, which converts the external light OL from the first polarized light P1 into right circularly polarized light RCP.

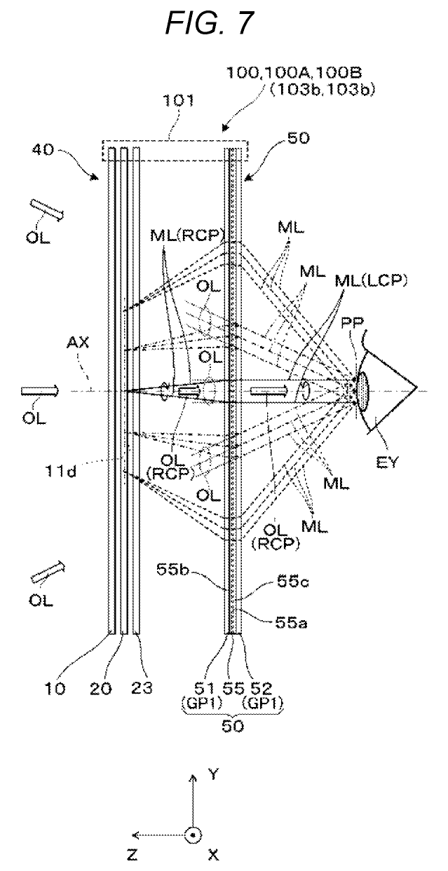

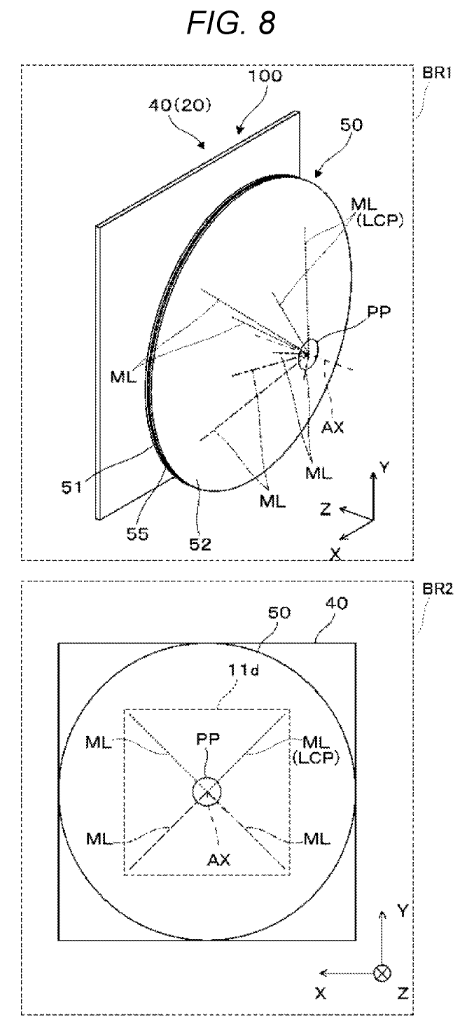

FIG. 7 is a side cross-sectional view showing the optical unit 100 configured with the display optical system 103aor 103b, and FIG. 8 shows the optical unit 100 viewed in other directions. In FIG. 8, a first region BR1 is a perspective view of the optical unit 100, and a second region BR2 is a rear view of the optical unit 100.

The optical unit 100 includes the display unit 40, which outputs the video light ML and transmits the external light OL, the imaging optical system 50, which functions as a positive lens or a collimator having positive power affecting the video light ML, and a support member 101, which fixes the display unit 40 and the imaging optical system 50 relative to each other.

In the imaging optical system 50, the first polarizing diffractive lens 51 alone functions as a positive lens when predetermined circularly polarized light is incident thereon, and the second polarizing diffractive lens 52 also alone functions as a positive lens when predetermined circularly polarized light is incident thereon. The switching half-wave plate 55 can be switched between an ON state and an OFF state, and causes the polarizing diffractive lenses 51 and 52 to each function as a positive lens when the switching half-wave plate 55 operates in the ON state, and cancels out the power of the polarizing diffractive lens 51 and the power of the polarizing diffractive lens 52 to cause the two lenses to function as a plane-parallel glass plate when the switching half-wave plate 55 operates in the OFF state.

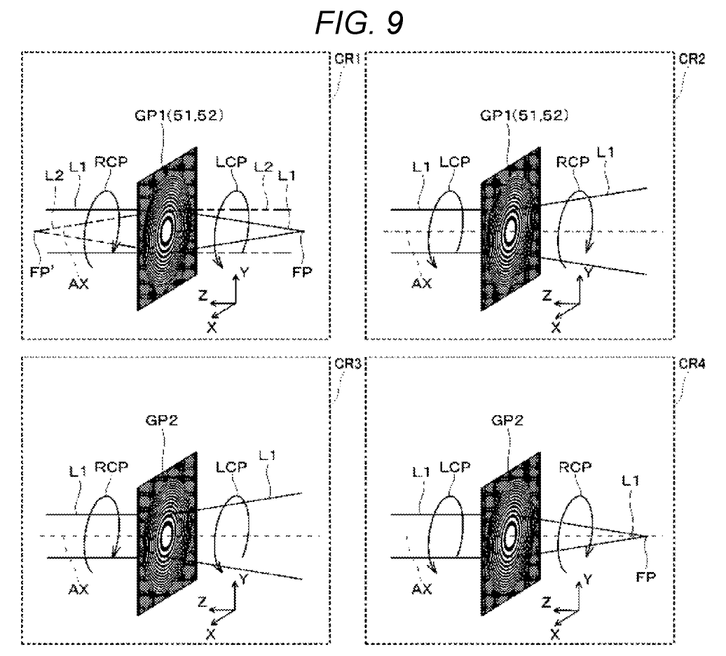

FIG. 9 is a conceptual perspective view illustrating the functions of the first polarizing diffractive lens 51 and the second polarizing diffractive lens 52. In FIG. 9, a first region CR1 shows a first operation example of a first-type polarizing diffractive lens GP1, and a second region CR2 shows a second operation example of the first-type polarizing diffractive lens GP1. In FIG. 9, a third region CR3 shows a first operation example of a second-type polarizing diffractive lens GP2, and a fourth region CR4 shows a second operation example of the second-type polarizing diffractive lens GP2. The first polarizing diffractive lens 51 and the second polarizing diffractive lens 52 shown in FIG. 2 are each the first-type polarizing diffractive lens GP1.

The polarizing diffractive lens GP1 has the following two functions: the function, performed when the collimated right circularly polarized light RCP such as a beam L1 indicated by the solid line is incident from the left side of the figure, of converting the right circularly polarized light RCP into the left circularly polarized light LCP and causing the left circularly polarized light LCP to converge into a spot at a focal point FP; and the function, performed when the collimated left circularly polarized light LCP such as the beam L1 indicated by the solid line is incident from the left side of the figure, of converting the left circularly polarized light LCP into the right circularly polarized light RCP and causing the right circularly polarized light RCP to diverge. Note that the polarizing diffractive lens GP1 has the function, performed when the right circularly polarized light RCP diverging from a focal point FP' on the left side of the figure such as a beam L2 indicated by the two-dot chain line is incident, of converting the right circularly polarized light RCP into the left circularly polarized light LCP and collimating the left circularly polarized light LCP. That is, the polarizing diffractive lens GP1 reverses the direction of rotation of the polarization direction of the right circularly polarized light RCP while functioning as a positive lens having a predetermined focal length and affecting the polarized light. The polarizing diffractive lens GP1 further reverses the direction of rotation of the polarization direction of the left circularly polarized light LCP while functioning as a negative lens having the same but opposite-sign focal length and affecting the polarized light. That is, the polarizing diffractive lens GP1 is an optical element having positive power affecting the right circularly polarized light RCP and negative power affecting the left circularly polarized light LCP.

The polarizing diffractive lens GP2 has the function, performed when the collimated right circularly polarized light RCP such as the beam L1 indicated by the solid line is incident from the left side of the figure, of converting the right circularly polarized light RCP into the left circularly polarized light LCP and causing the left circularly polarized light LCP to diverge. The polarizing diffractive lens GP2 has the function, performed when the collimated left circularly polarized light LCP such as the beam L1 indicated by the solid line is incident from the left side of the figure, of converting the left circularly polarized light LCP into the right circularly polarized light RCP and causing the right circularly polarized light RCP to converge into a spot at the focal point FP. That is, the polarizing diffractive lens GP2 reverses the direction of rotation of the polarization direction of the left circularly polarized light LCP while functioning as a positive lens having a predetermined focal length and affecting the polarized light. The polarizing diffractive lens GP2 further reverses the direction of rotation of the polarization direction of the right circularly polarized light RCP while functioning as a negative lens having the same but opposite-sign focal length and affecting the polarized light. That is, the polarizing diffractive lens GP2 is an optical element having negative power affecting the right circularly polarized light RCP and positive power affecting the left circularly polarized light LCP.

Each of the polarizing diffractive lenses GP1 and GP2 has refractive index anisotropy distribution understood in the form of a large number of annular zones formed in a plane around the optical axis AX, and functions as a diffractive lens in accordance with the refractive index anisotropy distribution and the polarization state of the incident light. Specifically, in the polarizing diffractive lenses GP1 and GP2, when each of which has a refractive index anisotropy distribution which causes the azimuth of the optic axis of the polarizing diffractive lens to rotate (in practice, repeatedly rotate within a range from 0 to π) as two directions perpendicular to each other and perpendicular to the optical axis AX, which is at the center of the lens, extend from the optical axis AX, a geometric phase is formed in specific circularly polarized light incident on the thus configured polarizing diffractive lens, and the circularly polarized light is diffracted at a diffraction angle reflecting the length of the cycle of the rotation of the optic axis with respect to each azimuth, so that the polarization state of the circularly polarized light is reversed. Each of the polarizing diffractive lenses as a whole diffracts the specific circularly polarized light in correspondence with the power formed by the lens shape, and reverses the state of the circularly polarized light, for example, from right circularly polarized light before passing through the lens to left circularly polarized light after passing through the lens.

Although not shown, each of the polarizing diffractive lenses GP1 and GP2 is configured with a transparent substrate on which a thin-film liquid-crystal-containing material layer is formed, and has a thin plate shape as a whole. The liquid-crystal-containing material layer contains a predetermined liquid crystal material, and an axis along which the liquid crystal molecules are aligned is made parallel, for example, to the X direction in a region near the optical axis AX so that an intended geometric phase is formed, and gradually rotates in an XY plane as the liquid-crystal-containing material layer extends from the optical axis AX, that is, in accordance with the distance from or the radius around the optical axis AX. That is, the angle of rotation of the axis along which the liquid crystal molecules are aligned increases in accordance with the distance from the optical axis AX, which is cyclically repeated. In a liquid crystal compound layer, the liquid crystal molecules are arranged in the Z direction parallel to the optical axis AX, for example, with the axis along which the liquid crystal molecules are aligned maintained fixed. Note in the polarizing diffractive lenses GP1 and GP2 that the angle of rotation of the axis along which the liquid crystal molecules are aligned is increased in opposite directions. As a method for manufacturing the polarizing diffractive lenses GP1 and GP2, for example, a liquid-crystal-containing material film, which is a mixture of a liquid crystal material and an ultraviolet curable organic material layer, is formed on a substrate, and the liquid-crystal-containing material film is two-dimensionally scanned with UV laser light in a predetermined polarization state, thereby curing the organic material layer while adjusting the axis along which the liquid crystal molecules are aligned. The axis along which the liquid crystal molecules are aligned can thus be three-dimensionally controlled and fixed in the liquid-crystal-containing material layer, so that a liquid crystal compound layer in which the angle of the rotation of the alignment axis increases as the distance from the optical axis AX increases is produced. The thus produced polarizing diffractive lens GP1 itself is known, for example, as a polarization-dependent liquid crystal Fresnel lens (see Kohei Noda, et al., Applied Optics, Feb. 10 2017, Vol. 56, No. 5: 1302, for example).

The polarizing diffractive lenses GP1 and GP2 do not need to be separate lenses, and the polarizing diffractive lens GP2 is obtained by rotating the polarizing diffractive lens GP1 around the Y-axis by 180° and flipping the rotated polarizing diffractive lens GP1 upside down. That is, the polarizing diffractive lenses GP1 and GP2 can each function as both a positive lens and a negative lens for the same circularly polarized light by flipping the lens upside down. The reason for this is that, in the polarizing diffractive lenses GP1 and GP2, since the angle of rotation of the axis along which the liquid crystal molecules are aligned is so increased that the alignment axis rotates in a specific direction in accordance with the distance from the optical axis AX as described above, the directions of the rotation of the alignment axes of the two lenses with respect to the absolute value of the distance in, for example, the ±X direction perpendicular to the optical axis AX coincide with each other, so that the alignment axes rotate in opposite directions when the polarizing diffractive lenses GP1 and GP2 is viewed from the rear side.

The focal length of the polarizing diffractive lens GP1 and the focal length of the polarizing diffractive lens GP2 can be increased or decreased by changing the manufacturing method or the liquid crystal material. In the liquid crystal compound layer, for example, when the angle of the rotation of the axis along which the liquid crystal molecules are aligned is increased as the distance from the optical axis AX increases, increasing the rate of the increase in the angle of rotation with respect to the distance or the radius from the optical axis AX, that is, shortening the length of the cycle of the rotation of the alignment axis can increase the absolute value of the positive or negative power of each of the polarizing diffractive lenses GP1 and GP2, so that the focal length of the lens can be adjusted. When the circularly polarized beam L1 passes through the polarizing diffractive lenses GP1 and GP2, the loss thereof is close to zero, so that the polarizing diffractive lenses GP1 and GP2 have almost 100% transmittance.

When linearly polarized light enters the polarizing diffractive lens GP1, the right circularly polarized light RCP and the left circularly polarized light LCP contained in the linearly polarized light behave differently. One of the components that is the right circularly polarized light RCP passes through the polarizing diffractive lens GP1, which causes the component to converge, the other component that is the left circularly polarized light LCP passes through the polarizing diffractive lens GP1, which causes the component to diverge, and the polarization directions of the two types of polarized light rotate in opposite directions.

Returning to FIG. 7, the switching half-wave plate 55 is a device that performs a switch-like operation in accordance with the drive signal from the drive circuit 81 shown in FIG. 2, and switches the polarization state of the incident light from the right circularly polarized light RCP to the left circularly polarized light LCP and causes the incident light to pass therethrough, or causes the right circularly polarized light RCP to pass therethrough with no change in the polarization state in accordance with the direction in which the liquid crystal molecules are aligned. That is, the switching half-wave plate 55 switches the state thereof between the ON state, in which the video light ML having passed through the first polarizing diffractive lens 51 is caused to return from the left circularly polarized light LCP, which is second circularly polarized light, to the right circularly polarized light RCP, which is first circularly polarized light, and the OFF state, in which the video light ML having passed through the first polarizing diffractive lens 51 passes through as the left circularly polarized light LCP, which is the second circularly polarized light, with no change in the polarization state. The switching half-wave plate 55 includes a liquid crystal layer 55asandwiched between a pair of bases 55b and 55c via transparent electrode layers that are not shown. The liquid crystal layer 55ais, for example, an IPS (in-plane switching) liquid crystal layer, and when receiving an electric field, the liquid crystal layer 55a causes the switching half-wave plate 55 to function as an optical element equivalent to a half-wave plate having a principal axis or a fast axis set in a specific direction (intermediate direction between X direction and Y direction, for example), and when receiving no electric field, the liquid crystal layer 55a causes the switching half-wave plate 55 to function as a plane-parallel plate. The switching half-wave plate 55 switches the state thereof between the ON state and the OFF state not on a pixel basis but across the entire surface.

In the imaging optical system 50, the first polarizing diffractive lens 51 is the polarizing diffractive lens GP1 shown in FIG. 9. When the video light ML and the external light OL incident from the display unit 40 are each the right circularly polarized light RCP, the first polarizing diffractive lens 51 functions as an optical element having positive power affecting the video light ML or the external light OL, and reverses the direction of rotation of the polarization direction of the light to produce the left circularly polarized light LCP while reducing the degree of divergence of the video light ML or the external light OL. The video light ML or the external light OL having passed through the first polarizing diffractive lens 51 enters the switching half-wave plate 55 as the left-handed circularly polarized light LCP.

The switching half-wave plate 55 operates in the ON state in the video observation period, that is, at the timing when the video light ML is incident, and operates in the OFF state in the external light observation period, that is, at the timing when the external light OL is incident.

In the video observation period, the switching half-wave plate 55 operating in the ON state converts the video light ML incident thereon from the left circularly polarized light LCP into the right circularly polarized light RCP, but transmits the video light ML without substantially causing the video light ML to converge, like a plane-parallel plate, and causes the video light ML to enter the second polarizing diffractive lens 52. The second polarizing diffractive lens 52 is the polarizing diffractive lens GP1 shown in FIG. 9. When the video light ML having passed through the switching half-wave plate 55 is the right circularly polarized light RCP, the second polarizing diffractive lens 52 functions as an optical element having positive power affecting the video light ML, and reverses the direction of rotation of the polarization direction of the light to produce the left circularly polarized light LCP while reducing the degree of divergence of the video light ML. In this configuration, the absolute value of the power of the first polarizing diffractive lens 51 and the absolute value of the power of the second polarizing diffractive lens 52 are set at the same value, and the combined focal length of the two polarizing diffractive lenses 51 and 52 is substantially comparable to the combined focal length of two thin convex lenses disposed adjacent to each other. When the combined focal length of the two polarizing diffractive lenses 51 and 52 is equal to the distance from the intermediate point of the two polarizing diffractive lenses 51 and 52 to a display surface 11d of the display unit 40, the imaging optical system 50 functions as a collimator and collects the video light ML at a pupil position PP while collimating the video light ML. Although FIG. 6 shows only the chief ray of the video light ML from the display surface 11d, FIGS. 7 and 8 show that the video light ML from the diagonal positions of the display surface 11d passes through the pupil position PP.

In contrast, in the external light observation period, the switching half-wave plate 55 operating in the OFF state maintains the external light OL incident thereon as the left circularly polarized light LCP, and causes the external light OL to enter the second polarizing diffractive lens 52. The second polarizing diffractive lens 52 is the polarizing diffractive lens GP1 shown in FIG. 9. When the external light OL having passed through the switching half-wave plate 55 is the left circularly polarized light LCP, the second polarizing diffractive lens 52 functions as an optical element having negative power affecting the external light OL, and reverses the direction of rotation of the polarization direction of the light to produce the right circularly polarized light RCP while reducing the degree of convergence of the external light OL. In this configuration, the two polarizing diffractive lenses 51 and 52 are disposed to be close to each other, and the absolute value of the power of one of the two lenses and the absolute value of the power of the other lens are set at the same value, so that the combined focal length of the two polarizing diffractive lenses 51 and 52 is infinity. When the combined focal length of the polarizing diffractive lenses 51 and 52 is infinity, the imaging optical system 50 functions as an element equivalent to a plane-parallel plate that is an optical system having substantially zero power, and therefore causes the external light OL to travel substantially straight without causing the external light OL to be collected or otherwise being brought into focus to realize a state in which the external light OL is observed with the naked eyes.

As described above, in the video observation period, the switching half-wave plate 55 operating in the ON state causes the imaging optical system 50 to have positive power, so that the video light ML can be observed, and in the external light observation period, the switching half-wave plate 55 operating in the OFF state causes the imaging optical system 50 to have substantially zero power, so that the external light OL can be observed. That is, the virtual image display apparatuses 100A and 100B or the display optical systems 103a and 103b, which perform the display operation described above, enable see-through display in which the video light ML and the external light OL are superimposed on each other in a time division manner.

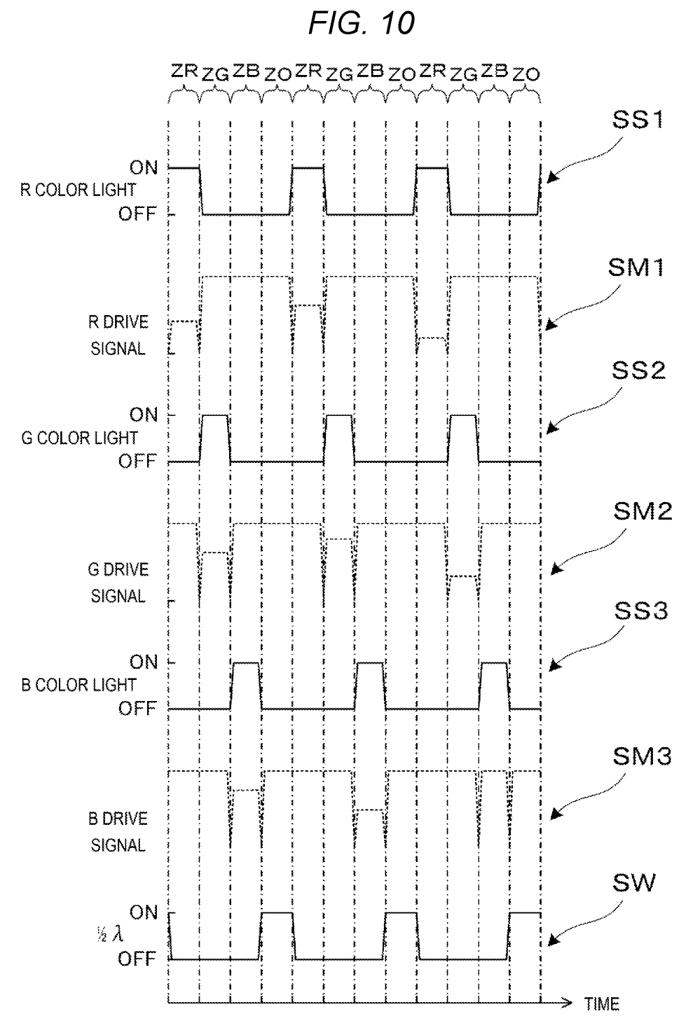

FIG. 10 is a timing chart illustrating the display operation performed by the display optical systems 103a and 103b. The horizontal axis of FIG. 10 represents time, and indicates, sequentially from the top, a blinking signal SS1 for the first light source 10R outputting light having the first color (R or red, for example), a first drive signal SM1 supplied to the transmissive liquid crystal panel 22 and used to display the first color component, a blinking signal SS2 for the second light source 10G outputting light having the second color (G or green, for example), a second drive signal SM2 supplied to the transmissive liquid crystal panel 22 and used to display the second color component, a blinking signal SS3 for the third light source 10B outputting light having the third color (B or blue, for example), a third drive signal SM3 supplied to the transmissive liquid crystal panel 22 and used to display the third color component, and an on/off signal SW for the switching half-wave plate (1/2 λ) 55. In the operation of the first virtual image display apparatus 100A, each frame includes a first sub-frame ZR, which is a sub-frame for first color video observation, a second sub-frame ZG, which is a sub-frame for second color video observation, a third sub-frame ZB, which is a sub-frame for third color video observation, and a fourth sub-frame ZO, which is a sub-frame for external light observation. The drive circuit 81 of the controller 80 outputs the blinking signals SS1, SS2, and SS3 to control the operations of the light sources 10R, 10G, and 10B, respectively, outputs the drive signals SM1, SM2, and SM3 to control the operation of the transmissive liquid crystal panel 22, and outputs the on/off signal SW to control the operation of the switching half-wave plate 55.

In this case, when the first virtual image display apparatus 100A shows the first sub-frame ZR of the video observation period, in which the first light source 10R outputs the first backlight BLR having the first color, and the transmissive liquid crystal panel 22 displays the first color component, the first virtual image display apparatus 100A displays first video light ML(R) representing the intensity distribution of the first color wavelength component out of the video light ML. Similarly, when the first virtual image display apparatus 100A shows the second sub-frame ZG of the video observation period, in which the second light source 10G outputs the second backlight BLG having the second color, and the transmissive liquid crystal panel 22 displays the second color component, the first virtual image display apparatus 100A displays second video light ML(G) representing the intensity distribution of the second color wavelength component out of the video light ML. Furthermore, when the first virtual image display apparatus 100A shows the third sub-frame ZB of the video observation period, in which the third light source 10B outputs the third backlight BLB having the third color, and the transmissive liquid crystal panel 22 displays the third color component, the first virtual image display apparatus 100A displays third video light ML(B) representing the intensity distribution of the third color wavelength component out of the video light ML. As described above, the first virtual image display apparatus 100A displays full-color video light ML by repeating the state of each of the sub-frames ZR, ZG, and ZB, in which the multiple types of video light ML (R), ML (G), and ML (B) representing the intensity distribution of the three-color wavelength components contained in the video light ML are displayed, one by one in a time division manner in a sufficiently short cycle.

In the first sub-frame ZR, the second light source 10G and the third light source 10B operate in a transmission state in which the second light source 10G and the third light source 10B output neither the backlight BLG nor the backlight BLB but transmit the backlight BLR output by the first light source 10R, and the transmissive liquid crystal panel 22 forms only the first video light ML(R) out of the video light ML but form neither the second video light ML(G) nor the third video light ML(B), so that only the first video light ML(R) representing the intensity distribution of the first color wavelength component out of the video light ML is displayed. Similarly, in the second sub-frame ZG, the first light source 10R operates in a transmission state in which the first light source 10R does not output the backlight BLR, the third light source 10B operates in a transmission state in which the third light source 10B does not output the third backlight BLB but transmits the second backlight BLG having the second color and output by the second light source 10G, and the transmissive liquid crystal panel 22 forms only the second video light ML(G) out of the video light ML but forms neither the first video light ML(R) nor the third video light ML(B), so that only the second video light ML(G) representing the intensity distribution of the second color wavelength component out of the video light ML is displayed. In the third sub-frame ZB, the first light source 10R and the second light source 10G operate in the transmission states, in which the first light source 10R does not output the backlight BLR and the second light source 10G does not output the backlight BLG, and the transmissive liquid crystal panel 22 forms only the third video light ML(B) out of the video light ML but forms neither the first video light ML(R) nor the second video light ML(G), so that only the third video light ML(B) representing the intensity distribution of the third color wavelength component out of the video light ML is displayed.

Assuming that the first virtual image display apparatus 100A shows the fourth sub-frame ZO as the external light observation period, in which the light sources 10R, 10G, and 10B operate in the transmission states, in which the light source 10R does not output the backlight BLR, the light source 10G does not output the backlight BLG, and the light source 10B does not output the backlight BLB, that the transmissive liquid crystal panel 22 operates in the non-video display state, and that the switching half-wave plate 55 operates in the OFF state, in which the switching half-wave plate 55 transmits the incident light as it is, the external light OL passes through the light sources 10R, 10G, and 10B, the transmissive liquid crystal panel 22, and the switching half-wave plate 55 and reaches the eye EY of the wearer US. As described above, the first virtual image display apparatus 100A repeats the following two states in a sufficiently short cycle: the state in which the first virtual image display apparatus 100A displays the first color component, the second color component, and the third color component of the video light ML in a time division manner in the video observation period including the sub-frames ZR, ZG, and ZB; and the state in which the first virtual image display apparatus 100A transmits the external light OL in the external light observation period as the sub-frame ZO, enabling see-through display in which the full-color video light ML and the external light OL are superimposed on each other in a time division manner.

The virtual image display apparatuses 100A and 100B or the optical unit 100 according to the first embodiment described above includes the light source member 10 as a transmissive OLED panel that transmits the external light OL in the first state and outputs the backlight BL containing the first backlight BLR in the second state, the display element 20, which is provided so as to face the light source member 10, further transmits the external light OL having passed through the light source member 10 in the first state, and transmits the backlight BL output by the light source member 10 to output the video light ML in the second state, and the imaging optical system 50, which is provided so as to face the light source member 10 with the display element 20 interposed therebetween, transmits at least part of the external light OL in the first state, and brings the video light ML into focus in the second state. The light source member 10 includes the first transmissive OLED element 1R, which outputs the first backlight BLR, and the first transmissive/reflective film 110R, which is provided on a side of the first transmissive OLED element 1R that is the side opposite the display element 20, reflects the first backlight BLR, and transmits the external light OL. The light source member 10 in the present embodiment further includes the second transmissive OLED element 1G, which is provided on a side of the first transmissive OLED element 1R that is the side facing the display element 20, transmits the external light OL in the first state, and outputs the second backlight BLG in the second state, and the second transmissive/reflective film 110G, which is provided on a side of the second transmissive OLED element 1G that is the side opposite the display element 20, reflects the second backlight BLG, and transmits the external light OL.

Since the virtual image display apparatuses 100A and 100B or the optical unit 100 described above uses the light source member 10 including the first transmissive/reflective film 110R, which reflects the first backlight BLR contained in the backlight BL, the second transmissive/reflective film 110G, which reflects the second backlight BLG contained in the backlight BL, and the third transmissive/reflective film 110B, which reflects the third backlight BLB contained in the backlight BL, leakage of the backlight BL toward the external space can be suppressed. The efficiency at which the backlight BL output from the light source member 10 is used can therefore be improved.

In addition, since the virtual image display apparatuses 100A and 100B or the optical unit 100 described above uses a transmissive OLED panel, which is a surface emitting source, as the light source member 10, which generates the backlight BL, the backlight BL can be uniformly output, so that luminance unevenness of an image can be suppressed.

In addition, using the transmissive OLED element allows reduction in power consumed to generate the backlight BL, reduction in the size of the light source member 10, and both an increase in transmittance for the external light OL and favorable display of the video light ML. Furthermore, in the virtual image display apparatuses 100A and 100B or the optical unit 100 described above, the first polarizing diffractive lens 51 having positive power affecting video light that is the first circularly polarized light is combined with the second polarizing diffractive lens 52 having positive power affecting video light that is the second circularly polarized light having passed through the first polarizing diffractive lens 51 each other to realize the imaging optical system 50 having a relatively small thickness and a relatively short focal length.

The technical scope of the present disclosure is not limited to the embodiment described above, and various changes can be made thereto to the extent that the changes do not depart from the intent of the present disclosure.

In addition, each of the light sources 10R, 10G, and 10B of the light source member 10 in the embodiment described above is configured with a transmissive OLED element, and may instead be configured with a micro-LED element in which multiple LED elements are two-dimensionally arranged. Note that the micro-LED element can transmit external light through a gap between the LED elements.

Furthermore, the light source member 10 in the embodiment described above includes three light sources by way of example, and the present disclosure is also applicable to a case where only one of the light sources 10R, 10G, and 10B is used.

It is assumed in the embodiment described above that the HMD 200 is used with the HMD 200 worn around the head. However, the virtual image display apparatuses 100A and 100B described above can also be used as a hand-held display that a user does not wear it around the head, but the user sees through it like binoculars. That is, in the present disclosure, the head mounted display also includes a hand-held display.

In addition to the above, the specific description of the shapes, the numbers, the arrangements, the materials, and other factors of the elements of the optical module and the projector are not limited to those in the embodiment described above and can be changed as appropriate.

The present disclosure will be summarized below as additional remarks.

### Additional Remark 1

A virtual image display apparatus including:

a light source member configured to transmit external light in a first state and output illumination light containing first light in a first wavelength band in a second state;

a display element provided to face the light source member and configured to further transmit the external light passing through the light source member in the first state, and transmit the illumination light output by the light source member to output video light in the second state; and

an imaging optical system provided to face the light source member with the display element interposed therebetween and configured to transmit at least part of the external light in the first state, and bring the video light into focus in the second state,

wherein the light source member includes

a first light emitter configured to emit the first light, and

a first transmissive/reflective film provided on a side of the first light emitter that is a side opposite the display element and configured to reflect the first light and transmit the external light.

The thus configured virtual image display apparatus, which includes the light source member including the first transmissive/reflective film, which reflects the first light contained in the illumination light, can suppress leakage of the first light contained in the illumination light toward the external space. The efficiency at which the illumination light output from the light source member is used can therefore be improved.

### Additional Remark 2

The virtual image display apparatus according to Additional Remark 1, wherein

the first transmissive/reflective film is a dielectric multilayer film.

The configuration described above, in which the first transmissive/reflective film is configured with a dielectric multilayer film, can realize a first transmissive/reflective film having a desired optical characteristic of reflecting the first light and transmitting the external light.

### Additional Remark 3

The virtual image display apparatus according to Additional Remark 1 or 2, wherein

the first light emitter includes a first transparent substrate, and

the first transmissive/reflective film is provided at a surface of the first transparent substrate that is a side opposite the display element.

The configuration described above, in which the first transmissive/reflective film is formed at the first transparent substrate, allows formation of a first transmissive/reflective film having a stable film thickness. A first transmissive/reflective film having the desired optical characteristic can therefore be realized.

### Additional Remark 4

The virtual image display apparatus according to any one of Additional Remarks 1 to 3, wherein

the light source member further includes

a second light emitter provided on a side of the first light emitter that is a side facing the display element and configured to transmit the external light in the first state and output second light in a second wavelength band different from the first wavelength band in the second state, and

a second transmissive/reflective film provided on a side of the second light emitter that is a side opposite the display element and configured to reflect the second light and transmit the external light.

The configuration described above, in which the light source member includes the second transmissive/reflective film, which reflects the second light contained in the illumination light, can suppress leakage of the second light contained in the illumination light toward the external space. The efficiency at which the illumination light output from the light source member is used can therefore be further improved.

### Additional Remark 5

The virtual image display apparatus according to Additional Remark 4, wherein

the second light emitter includes a second transparent substrate, and

the second transmissive/reflective film is provided at a surface of the second transparent substrate that is a side opposite the display element.

The configuration described above, in which the second transmissive/reflective film is formed at the second transparent substrate, allows formation of a second transmissive/reflective film having a stable film thickness. A second transmissive/reflective film having a desired optical characteristic can therefore be provided.

### Additional Remark 6

The virtual image display apparatus according to any one of Additional Remarks 1 to 5, wherein

a reflection center wavelength of the light reflected off the first transmissive/reflective film falls within the first wavelength band.

The configuration described above allows the first transmissive/reflective film to efficiently reflect the first light.

### Additional Remark 7

The virtual image display apparatus according to Additional Remark 6, wherein

the reflection center wavelength is closer to 555 nm than a peak wavelength of the first wavelength band.

The configuration described above, in which the reflection center wavelength is brought closer to 555 nm, at which of human visual sensitivity peaks, than the peak wavelength of the first light, allows the first transmissive/reflective film to efficiently reflect highly visible components in the wavelength band to which the first light belongs.

### Additional Remark 8

An optical unit including:

a light source member configured to transmit external light in a first state and output illumination light containing first light in a first wavelength band in a second state;

a display element provided to face the light source member and configured to further transmit the external light passing through the light source member in the first state, and transmit the illumination light output by the light source member to output video light in the second state; and

an imaging optical system provided to face the light source member with the display element interposed therebetween and configured to transmit at least part of the external light in the first state, and bring the video light into focus in the second state,

wherein the light source member includes

a first light emitter configured to emit the first light, and

a first transmissive/reflective film provided on a side of the first light emitter that is a side opposite the display element and configured to reflect the first light and transmit the external light.

The thus configured optical unit, which includes the light source member including the first transmissive/reflective film, which reflects the first light contained in the illumination light, can suppress leakage of the first light contained in the illumination light toward the external space. The efficiency at which the illumination light output from the light source member is used can therefore be improved.

What is claimed is:

1. A virtual image display apparatus, comprising:
a light source member configured to transmit an external light in a first state and output an illumination light containing a first light in a first wavelength band in a second state;
a display element provided to face the light source member and configured to further transmit the external light passing through the light source member in the first state, and transmit the illumination light output by the light source member to output a video light in the second state; and
an imaging optical system provided to face the light source member with the display element interposed therebetween and configured to transmit at least part of the external light in the first state, and bring the video light into focus in the second state,
wherein the light source member includes
a first light emitter configured to emit the first light, and
a first transmissive/reflective film provided on a side of the first light emitter that is a side opposite the display element and configured to reflect the first light and transmit the external light.

2. The virtual image display apparatus according to claim 1, wherein
the first transmissive/reflective film is a dielectric multilayer film.

3. The virtual image display apparatus according to claim 1, wherein
the first light emitter includes a first transparent substrate, and
the first transmissive/reflective film is provided at a surface of the first transparent substrate that is a side opposite the display element.

4. The virtual image display apparatus according to claim 1, wherein
the light source member further includes
a second light emitter provided on a side of the first light emitter that is a side facing the display element and configured to transmit the external light in the first state and output a second light in a second wavelength band different from the first wavelength band in the second state, and
a second transmissive/reflective film provided on a side of the second light emitter that is a side opposite the display element and configured to reflect the second light and transmit the external light.

5. The virtual image display apparatus according to claim 4, wherein
the second light emitter includes a second transparent substrate, and
the second transmissive/reflective film is provided at a surface of the second transparent substrate that is a side opposite the display element.

6. The virtual image display apparatus according to claim 1, wherein
a reflection center wavelength of the light reflected off the first transmissive/reflective film falls within the first wavelength band.

7. The virtual image display apparatus according to claim 6, wherein
the reflection center wavelength is closer to 555 nm than a peak wavelength of the first wavelength band.

8. An optical unit, comprising:
a light source member configured to transmit an external light in a first state and output an illumination light containing a first light in a first wavelength band in a second state;
a display element provided to face the light source member and configured to further transmit the external light passing through the light source member in the first state, and transmit the illumination light output by the light source member to output a video light in the second state; and
an imaging optical system provided to face the light source member with the display element interposed therebetween and configured to transmit at least part of the external light in the first state, and bring the video light into focus in the second state,
wherein the light source member includes
a first light emitter configured to emit the first light, and
a first transmissive/reflective film provided on a side of the first light emitter that is a side opposite the display element and configured to reflect the first light and transmit the external light.
